(19) United States
(12) Patent Application Publication
(10) Pub. No.: US 2023/0154460 A1
(43) Pub. Date: May 18, 2023

(54) DIGITAL ASSISTANT DEVICE FOR RESOLVING COMMAND CONFLICTS

(71) Applicant: LENOVO (SINGAPORE) PTE. LTD., New Tech Park (SG)

(72) Inventors: Robert James Norton, JR., Raleigh, NC (US); Justin Michael Ringuette, Morrisville, NC (US); Sandy Collins, Durham, NC (US)

(21) Appl. No.: 17/455,478

(22) Filed: Nov. 18, 2021

(51) Int. Cl. G10L 15/22

(52) U.S. Cl. CPC G10L 15/22

(57) ABSTRACT

A digital assistant device includes one or more microphones held by a housing, a memory, and one or more processors. The microphones receive a voice command. The one or more processors execute program instructions in the memory to interpret the voice command as instructing performance of a first function, identify a source of the voice command, and determine whether the performance of the first function would conflict with performance of a second function. In response to determining that the performance of the first function would conflict with the performance of the second function, the one or more processors determine whether the source of the voice command has authority to override the second function. The one or more processors perform the first function according to the voice command in response to determining that the source of the voice command has the authority to override the second function.

### FIELD

The present disclosure relates generally to electronic devices that include speech-recognizable digital personal assistant applications.

### BACKGROUND OF THE INVENTION

Digital assistant applications on electronic devices utilize speech recognition algorithms to interpret and respond to spoken commands of a person in the surrounding environment of the device. Digital assistants can be used to perform a variety of tasks designed to provide information, entertainment, control “smart” external devices within a connected ecosystem, assist with organizational tasks, and the like. The devices that include digital assistant applications can be speaker devices, smartphones, tablet computers, laptop computers, desktop computers, wearable computers, and the like. Devices that include digital assistant applications are referred to herein as digital assistant devices.

Some digital assistant devices are disposed in multi-user environments in which multiple different people are able to communicate with the same digital assistant device. One example is in a home, as multiple members of a family can provide voice commands to the same digital assistant device. Another example is in a business environment in which multiple employees of the business can communicate with the same digital assistant device. Digital assistant devices in multi-user environments may not differentiate between users. For example, voice commands are treated chronologically regardless of the source of the voice command. This control strategy can lead to problems when the digital assistant device receives conflicting voice commands. For example, if two users disagree about which song for the digital assistant device (or a connected audio speaker system) to play, the digital assistant device may receive alternating voice commands from the two users to play different songs. As a result, the digital assistant device keeps switching the songs back and forth without finishing either song. Fighting over which song to play is one example of various different types of conflicting voice commands that a digital assistant device may receive.

A need remains for improved digital assistant devices and methods that overcome the disadvantages discussed above and other disadvantages in conventional systems that will become apparent herein.

### SUMMARY

In accordance with an embodiment, a digital assistant (DA) device is provided that includes a housing, one or more microphones held by the housing, a memory configured to store program instructions, and one or more processors operably connected to the memory. The program instructions are executable by the one or more processors to interpret a voice command received by the one or more microphones as instructing performance of a first function. The program instructions are also executable by the one or more processors to identify a source of the voice command, and determine whether the performance of the first function would conflict with performance of a second function. In response to determining that the performance of the first function would conflict with the performance of the second function, the one or more processors execute the program instructions to determine whether the source of the voice command has authority to override the second function. The one or more processors execute the program instructions to perform the first function according to the voice command in response to determining that the source of the voice command has the authority to override the second function.

Optionally, the one or more processors are configured to identify the source of the voice command by performing voice recognition analysis of the voice command to associate the voice command with a voice of a particular person.

The one or more processors may be configured to determine whether the performance of the first function would conflict with performance of a second function by determining whether the performance of the first function would interfere with an ability of the DA device to perform the section function and/or a reception of the second function by an observer.

Optionally, the one or more processors are configured to determine whether the source of the voice command has authority to override the second function by consulting a database that includes user rankings. The one or more processors determine that the source of the voice command has the authority to override the second function in response to the source of the voice command having a greater ranking in the database than a user that commanded the second function. The one or more processors may be configured to modify the user rankings in the database based on a behavioral analysis of plural voice commands received by the one or more microphones over time.

Optionally, responsive to determining that the source of the voice command does not have the authority to override the second function, the one or more processors are configured to deny the voice command such that the first function is not performed according to the voice command.

The one or more processors may be configured to perform the first function according to the voice command by one or more of responding to a request for information, generating a control signal to modify operation of an external device or appliance, or modifying an organizational tool.

Optionally, after determining that the source of the voice command has the authority to override the second function, the one or more processors are configured to confirm that the source of the voice command has authority to command the performance of the first function prior to performing the first function. In one aspect, the one or more processors are configured to confirm that the source of the voice command has the authority to command the performance of the first function by consulting a user database that lists an authority level for the user, and comparing the authority level of the user to an authority level in which the first function is categorized.

In accordance with an embodiment, a method is provided that includes receiving a voice command via one or more microphones of a DA device. The voice command instructs performance of a first function. The method includes identifying a source of the voice command, and determining whether the performance of the first function would conflict with performance of a second function. In response to determining that the performance of the first function would conflict with the performance of the second function, the method includes determining whether the source of the voice command has authority to override the second function. In response to determining that the source of the voice command has the authority to override the second function, the method includes performing, by the DA device, the first function according to the voice command.

Optionally, identifying the source of the voice command comprises performing voice recognition analysis of the voice command to associate the voice command with a voice of a particular person.

Determining whether the performance of the first function would conflict with the performance of the second function comprises determining whether the performance of the first function would interfere with an ability of the DA device to perform the section function and/or a reception of the second function by an observer.

Optionally, determining whether the source of the voice command has authority to override the second function includes consulting a database that includes user rankings. The source of the voice command is determined to have the authority to override the second function in response to the source of the voice command having a greater ranking in the database than a user that commanded the second function. In an aspect, the method also includes modifying the user rankings in the database based on a behavioral analysis of plural voice commands received by the one or more microphones of the DA device over time.

Responsive to determining that the source of the voice command does not have the authority to override the second function, the method may include denying the voice command such that the first function is not performed.

Optionally, performing the first function according to the voice command includes one or more of responding to a request for information, generating a control signal to modify operation of an external device or appliance, or modifying an organizational tool.

Optionally, after determining that the source of the voice command has the authority to override the second function, the method includes confirming that the source of the voice command has authority to command the performance of the first function prior to performing the first function. In an aspect, the source of the voice command may be confirmed as having the authority to command the performance of the first function by consulting a user database that lists an authority level for the user and comparing the authority level of the user to an authority level in which the first function is categorized.

In accordance with an embodiment, a computer program product comprising a non-transitory computer readable storage medium is provided. The non-transitory computer readable storage medium includes computer executable code to receive a voice command via one or more microphones of a digital assistant (DA) device. The voice command instructs performance of a first function. The non-transitory computer readable storage medium further comprises executable code to identify a source of the voice command and determine whether the performance of the first function would conflict with performance of a second function. In response to determining that the performance of the first function would conflict with the performance of the second function, the computer executable code is executed to determine whether the source of the voice command has authority to override the second function, and, in response to determining that the source of the voice command has the authority to override the second function, perform the first function according to the voice command.

Optionally, the non-transitory computer readable storage medium includes executable code to identify the source of the voice command by performing voice recognition analysis of the voice command to associate the voice command with a voice of a particular person.

### BRIEF DESCRIPTION OF THE DRAWINGS

FIG. 1 is a block diagram of a digital assistant (DA) device according to an embodiment.

FIG. 2 is a flow chart of a method of resolving voice command conflicts via the DA device according to an embodiment.

FIG. 3 illustrates a hierarchical table according to an embodiment.

FIG. 4 illustrates a top plan view of an environment in which embodiments herein may be implemented.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

Embodiments described herein disclose a digital assistant device and method that can differentiate between users and react to conflicting voice commands by establishing a hierarchy in multi-user environments. The hierarchy determines which user has priority when multiple users are trying to access the digital assistant. The hierarchy may include a ranking system in which some users are identified as having a higher rank, priority, and/or authority level as other users. The hierarchy is used to resolve conflicting voice commands without the digital assistant reacting equally to all received commands. In response to receiving a voice command, the digital assistant device and method described herein determines (e.g., predicts) whether implementing a candidate function according to the voice command would conflict with another, pre-existing function of the digital assistant device. If a conflict is present, then the digital assistant device and method determine whether the user that submitted the voice command to perform the candidate function has authority and/or rank to override and supersede the pre-existing function with the candidate function. In the scenario above in which two users are arguing over which song to play by submitting conflicting voice commands, the digital assistant device would resolve the conflict in favor of the user that has the higher relative ranking in the hierarchy. For example, the hierarchy may rank parents and authority figures higher than children to enable override of commands given by children, as well as deny voice commands of children that would interfere with commands given by a parent or authority figure. In a business environment, a boss may have priority over conflicting commands provided by a lower-ranked employee.

The terms “neural network” and “machine learning” refer to an artificial intelligence algorithm that learns from various automatic or manual feedback, such as observations and/or data. The artificial intelligence algorithm is adjusted over multiple iterations based on the observations and/or data. For example, the artificial intelligence algorithm is adjusted by supervised learning, unsupervised learning, and/or reinforcement learning (e.g., customer feedback). Non-limiting examples of artificial intelligence algorithms are a decision tree, K-means, deep learning, artificial neural network, and/or the like.

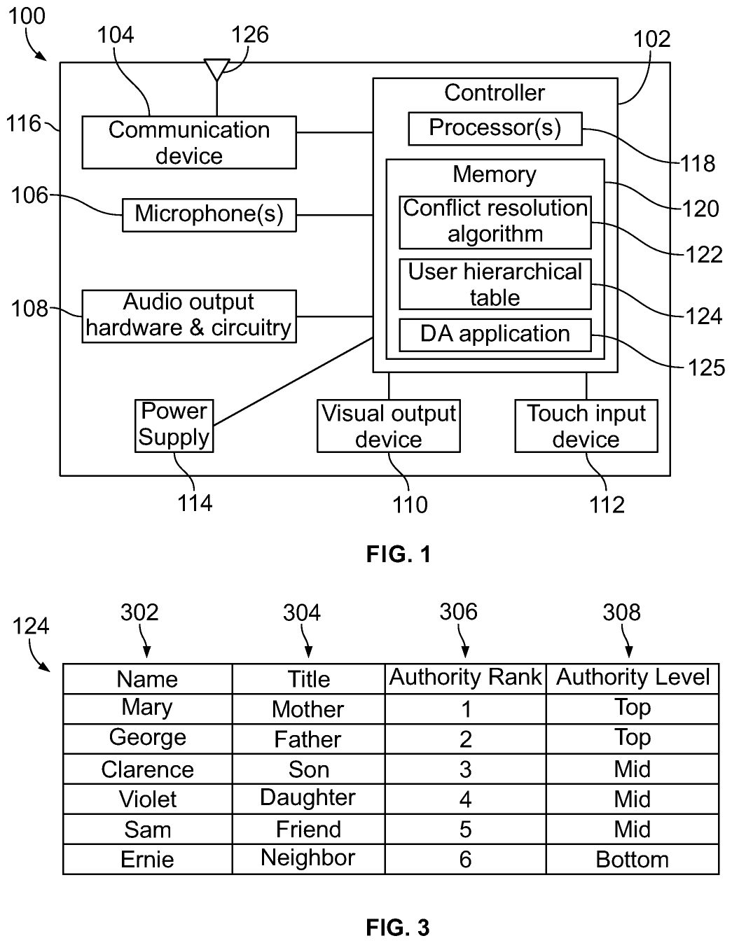

FIG. 1 is a block diagram of a digital assistant (DA) device 100 according to an embodiment. The DA device 100 includes a controller 102, a communication device 104, one or more microphones 106, an audio output hardware and circuitry 108, a visual output device 110, a touch input device 112, and a power supply 114. These components may be held within and/or on a housing 116. The DA device 100 may include additional components as well. The DA device 100 according to an alternative embodiment may omit one or more of the components shown in FIG. 1, such as the touch input device 112. The DA device 100 may be a speech-recognition capable device. For example, the DA device 100 may be a hands-free, audio speaker device, a smartphone, a tablet computer, a laptop computer, a desktop computer, a wearable computer, and the like.

The controller 102 is operably connected to the other components via wired and/or wireless communication links. The controller 102 represents hardware circuitry that includes and/or is connected with one or more processors 118 (e.g., one or more microprocessors, integrated circuits, microcontrollers, field programmable gate arrays, etc.). The controller 102 includes and/or is connected with a tangible and non-transitory computer-readable storage medium, referred to herein as memory 120. The memory 120 may store programmed instructions (e.g., software) that is executed by the one or more processors to perform the voice command conflict resolution operations described herein. The programmed instructions may include a conflict resolution algorithm 122. For example, the one or more processors 118 of the controller 102 may respond to a voice command, according to the conflict resolution algorithm 122, which is used to determine whether or not to perform a function requested by the voice command. The memory 120 may store a user database that includes information about known users of the DA device 100. The user database may include user identifiers, titles, authority information, a historical record of prior voice commands submitted by the users, and the like. The user database may include voice-recognition data that is utilized to identify the source of a voice command based on the source's voice. In an embodiment, the user database includes or represents a hierarchical table 124 that provides relative rankings of the users. The hierarchical table 124 may be utilized by the one or more processors 118 when implementing the conflict resolution algorithm 122. The hierarchical table 124 may be accessed to determine whether a candidate function according to a received voice command is to be performed in replacement of a conflicting, pre-existing function.

A digital assistant (DA) application 125 (e.g., program) is stored in the memory 120. The DM application 125 includes program instructions accessible by the one or more processors 118 to direct the one or more processors 118 to implement the methods, processes, and operations described herein. The DM application 125 may manage operation of one or more other components of the device 100 to parse the spoken words of received voice commands, analyze the commands, and route the commands to appropriate web-based services (e.g., cloud hosting services) based on the content and category of the commands. The DM application 125 may then receive responses from the web-based services, convert the responses, and then generate a control signal to control an audio speaker to emit a computer-generated “spoken” answer to one or more people in the environment. In an embodiment, the DA application 125 is used with the conflict resolution algorithm 122. For example, the conflict resolution algorithm 122 may be used to determine which voice commands the DA application 125 responds to, and which voice commands the DA application 125 denies or ignores. Other applications stored in the memory 120 include various application program interfaces (APIs), some of which provide links to and/or from a cloud hosting service.

The communication device 104 represents hardware circuitry that can wirelessly communicate electrical signals. For example, the communication device 104 can represent transceiving circuitry, one or more antennas 126, and the like. The transceiving circuitry may include a transceiver or a separate transmitter and receiver. The electrical signals can form data packets that in the aggregate represent messages. The communication device 104 can transmit or broadcast messages that are generated by the controller 102. The communication device 104 may receive messages and forward the message content to the controller 102 for analysis of the received messages. For example, the communication device 104 may be communicatively connected, via a wired or wireless communication link, to a network modem and/or router. The communication device 104 is able to communicate with various web services in the cloud via the modem and/or router.

The communication device 104 may be communicatively connected to various external devices and/or appliances in the local environment surrounding the DA device 100. External devices represent devices that are discrete and not physically connected to the DA device 100. The external devices may be “smart”-enabled devices with circuitry configured to allow the external devices to be controlled via a hub device (e.g., the DA device 100) within a connected ecosystem. Suitable external devices and appliances that may connect to the DA device 100 include lights (e.g., room lighting systems), televisions, audio speakers, fireplace inserts, thermostats and/or other HVAC components, sprinklers, fireplace inserts, kitchen appliances (e.g., stove/range, oven, microwave, refrigerator, etc.), and the like. The communication device 104 may be connected to these devices and/or appliances via Bluetooth, a local network connection, or the like. Optionally, the communication device 104 may include an infrared (IR) transmitter/receiver that may be utilized in connection with controlling one or more external devices or appliances through transmission and reception of IR signals. The communication device 104 enables the DA device 100 to transmit control signals to control operation of the external devices and/or appliances, without requiring manual interaction with the devices and/or appliances.

The one or more microphones 106 include transducers that convert soundwaves into electrical signals. The one or more microphones may include amplifiers, filters, and/or the like for conditioning the signals conveyed to the controller 102. The DA device 100 uses the microphones to receive voice commands. Optionally, the microphones may also be used to monitor for a designated sound and/or sound pattern used to wake the DA device from a low power sleep mode. The designated sound and/or sound pattern may include a proper name, such as “Alexa” (trademark of Amazon.com, Inc.) or “Hey Siri” (trademark of Apple Inc.). The controller 102 may utilize beamforming technology and noise cancellation to isolate received voice commands.

The audio output hardware and circuitry 108 includes one or more speakers and associated circuitry such as drivers, amplifiers, and the like. The audio output hardware and circuitry 108 generates and emits sounds to play music, respond via automated speech to voice commands, emit the voice of a caller during a phone conversation, and the like. The speakers may be omnidirectional.

The visual output device 110 may include a display screen that presents graphical indicia, such as text and symbols. The display screen may be mounted along a surface of the housing 116 to allow observers viewing the housing 116 to see the display screen. The visual output device in addition or alternatively may include one or more LED lights that indicate device status, such as whether the device is On or Off, that the DA device 100 is actively “listening” for a voice command, that the DA device 100 is actively searching for a response to a voice command, and/or the like.

The touch input device 112 may include one or more buttons, switches, touch sensitive pads, or the like, mounted on the housing 116. The touch input device 112 can be used to selectively turn On and Off the DA device 100, rouse the DA device 100 from the sleep mode to the wake mode to enable a person to provide a voice command without first providing the designated sound or sound pattern, play, pause, and/or select audio (e.g., song, podcast, audio book) output by the DA device 100, modify a volume of the audio being output, and/or the like. In an alternative embodiment, the DA device 100 omits the touch input device 112.

The power supply 114 provides electric current to power the operations of the DA device 100. In an embodiment, the power supply 114 includes a power adapter that is electrically connected to a plug connector. The plug connector may plug into a wall-mounted power outlet in a building to supply power to the DA device 100. The power supply 114 optionally may include an electrical energy storage device, such as one or more battery cells, capacitors, or the like. The electrical energy storage device of the power supply 114 may provide power to the components of the DA device 100 when unplugged from an external power source. The electrical energy storage device may provide portability to the DA device 100. The power supply 114 may also include charging circuitry for recharging the electrical energy storage device.

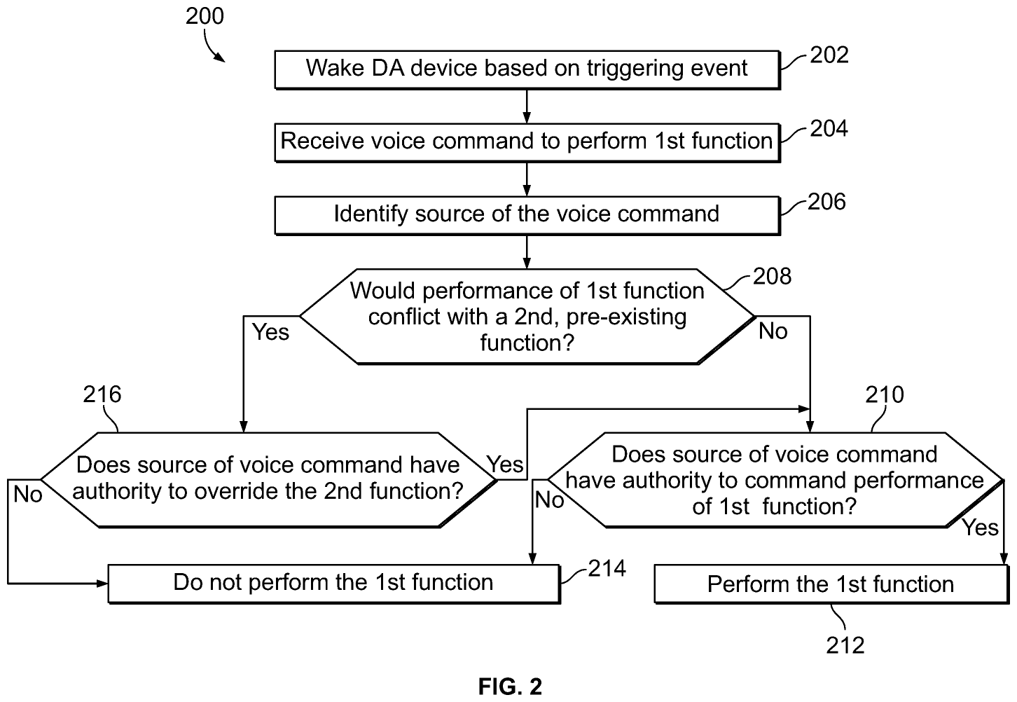

FIG. 2 is a flow chart 200 of a method of resolving voice command conflicts via a digital assistant (DA) device according to an embodiment. The method may be performed, at least in part, by the one or more processors 118 of the DA device 100 shown and described with reference to FIG. 1. For example, the one or more processors 118 may implement the conflict resolution algorithm 122 stored in the memory 120 to perform the method. Optionally, some aspects of the method may be performed by one or more processors of one or more external devices communicatively connected to the DA device 100. The one or more external devices may include a server or computer remote from the DA device 100. The server or computer may be located at a computing facility, data storage facility, or the like. The server or computer may perform cloud-based operations, such as voice recognition analysis and/or information searching operations. The method optionally may include at least one additional step than shown, at least one fewer step than shown, and/or at least one different step than shown.

At step 202, a triggering event occurs that prompts the DA device 100 to transition from a sleep mode to a wake mode. The triggering event may be detection, via the one or more microphones 106, of a designated sound and/or sound pattern that is used as a signal to wake the DA device 100 from a low power sleep mode. Another suitable triggering event may be detection of a user touch input on a button of the DA device 100. Transitioning from the sleep mode to the wake mode activates one or more components that are inactive in the sleep mode. Upon entering the wake mode, the DA device 100 monitors incoming audio signals (e.g., waveforms), received via the microphones 106, for voice commands. The DA device 100 may monitor for incoming audio signals for a designated period of time post waking, referred to herein as a listening window. The period of time may be 10 seconds or the like. If no voice command is received within the listening window, the DA device 100 may switch back to the sleep mode. The DA device 100 may also return to performing any function that was being performed at the time that the triggering event occurred and was paused during the listening period.

At step 204, a voice command is received by the DA device 100 that instructs performance of a first function. The voice command is an audio signal received by the one or more microphones 106. At least a portion of the voice command may be received before the listening period expires. The one or more processors of the DA device 100 analyze the voice command to interpret the voice command as instructing performance of the first function. The interpretation may include parsing the voice command into a series of audio segments associated with known words and phrases in a database.

The first function may be to control one or more external devices that are communicatively connected to the DA device 100. Suitable external devices include a thermostat, vacuum, a lighting system and/or individual lights, a security system, a music player, appliances, a television, a fireplace insert, and the like. The first function is not limited to controlling operation of another device. The first function may be to deliver information to a source of the voice command. The information sought may include public information such as news, sports headlines, weather forecasts, and the like. The first function may also be to update organizational tools, such as to add an entry to a to-do list, to set a reminder, timer, and/or alarm, to update a shopping list, to add an entry to a calendar, and/or the like. The voice command may be an imperative sentence or an interrogative sentence. For example, the voice command may be, “play the next song,” “turn on the lights,” “preheat the oven to 375 degrees”, “what is the temperature?,” or the like.

At step 206, the one or more processors identify a source of the voice command. As stated above, reference to one or more processors in the description of this method 200 may represent the one or more processors 118 of the DA device 100 and/or one or more processors of at least one external device communicatively connected to the DA device 100. The source of the voice command is the particular person or entity that spoke the voice command to perform the first function. In an embodiment, the source of the voice command is determined based on voice recognition analysis of the voice command. For example, one or more processors analyze audio characteristics of the voice command to associate the voice command with the voice of a particular user (e.g., person). The audio characteristics may include intonation, speed of speech, frequency of sounds, amplitude of sounds, patterns of sounds, patterns of words, and/or the like. The one or more processors that perform the voice recognition task may include at least one processor of a computer and/or server located remote from the DA device 100 and connected to the DA device 100 via a network (e.g., the Internet). Optionally, the one or more processors 118 may perform at least a portion of the voice recognition task. The one or more processors may utilize a voice recognition algorithm enhanced with machine learning to improve with use and experience. For example, the voice recognition algorithm may include neural network.

The DA device 100 optionally supports voice training sessions, in which users of the DA device 100 interact with the DA device 100 by speaking various commands, reviewing how the system interprets the commands, and correcting misinterpretations. The misinterpretations may be corrected by interacting with the DA device 100 using speech, the touch input device 112 of the DA device 100, and/or an external device communicatively connected to the DA device 100. The external device may be a remote control, a smartphone, a tablet computer, or a laptop computer. For example, a user interface on the visual output device 110 or external computing device may display text and graphics cards showing recent interactions and descriptions indicating how the system interpreted previous voice statements. The user interface may provide an opportunity for the user to provide feedback to confirm correct interpretations and fix misinterpretations. The voice recognition algorithm may adapt to the particular speech patterns, word usage, accent, volume, and intonation of the user over time.

Through training and/or experience over time, the DA device 100 may establish a user database that includes information about users of the DA device 100. In an example in which the DA device 100 is in a family home, each of the family members that interact with the DA device 100 may constitute a different user. Identifying information about the users may be stored in the user database. The user database may also include speech information about the users, which can be utilized for the voice recognition task to identify the source of a received voice command. The user database may be stored locally in the memory 120 of the DA device 100 or remotely at one or more servers or computers connected to the DA device 100 via a network. The user database may associate a unique identifier with each of the voice-recognizable users. The unique identifier may be a name, a title, an employee identification number, or the like. When the voice command is received, the DA device 100 uses voice recognition to attempt to determine the source of the voice command. In a family home, the source of the voice command may be a name such as “Mary” and/or a title such as Mother. In a business environment, the source may be a name, a position title such as “operations supervisor,” an employee identification number, or the like.

In an embodiment, if the one or more processors not able to identify the source of the voice command, the one or more processors may generate a control signal to attempt to identify the source after the failed voice recognition. The control signal may control the audio output hardware 108 (e.g., speakers) of the DA device 100 to ask the source to repeat the voice command for a second voice recognition attempt. Alternatively, or in addition, the control signal may control the audio output hardware 108 to respond to the voice command with an audio message that requests additional information from the source of the voice command. The information that is requested may be a personal identifier of the source. Suitable personal identifiers of the source can include a name, a title, a user name, a pin number, an employee identification number, and the like. Upon receipt of the requested additional information, the DA device 100 may compare the received information to information in the user database to determine if the source is a known user in the database. If the received information matches a known user in the database, then the one or more processors identify the source as the user in the database that matches. If the received information does not match any known users in the database, the DA device 100 may classify the source as unrecognized. An unrecognized source has a low ranking in a user hierarchy. In an alternative embodiment, if the one or more processors are not able to identify the source of the voice command via voice recognition, the one or more processors may classify the source as unrecognized without requesting additional information from the source.

At step 208, the one or more processors determine whether performance of the first function would cause a conflict with a second function. The one or more processors predict a conflict if performing the first function is expected to interfere with the performance of the second function. The second function is previously established or commanded relative to the first command. The second function is referred to herein as a pre-existing function, and the first function received in the voice command is referred to herein as a candidate function. The pre-existing function may pre-date the voice command. For example, the pre-existing function may be instructed in a prior voice command (before the voice command that instructs the candidate function is received). Alternatively, the pre-existing function may be instructed via a user touch input on the touch input device 112 and/or an external device communicatively connected to the DA device 100. The pre-existing function may be performed during a single time frame (e.g., “play next song” of a playlist or album) or may have recurring performance (e.g., “set lights to level 5 from 5 PM to 9 PM every night”). The pre-existing function may be being performed at a time that the voice command is received or may not be being performed, but may be scheduled to commence at a time that would overlap performance of the candidate function.

The one or more processors predict the candidate function to interfere with the pre-existing function if performing the candidate function would interrupt or degrade at least one of the performance of the pre-existing function and/or the reception of the pre-existing function by an observer. In an example, the pre-existing function may be to play a specific song, “Song 1”, on the audio output hardware 108 (e.g., speakers) of the DA device 100 or speakers of a connected external audio device, and the candidate function may be to play a different song, “Song 2”, on the same speakers while the speakers are playing Song 1. This situation represents a conflict because switching the songs mid-track would interrupt the performance of Song 1. Optionally, a conflict may also be determined if the candidate function alters how the pre-existing function is performed. For example, continuing with the “Song 1” example, a conflict may be predicted if the candidate function is to stop the track, change the volume of the track, or to seek information from the DA device 100 (e.g., news, weather forecast, sports score, etc.) while Song 1 is being played. Pausing the song, changing the volume, and/or responding to a request for information would affect the performance of the song.

The conflict determination may be constrained by time, such that two otherwise conflicting functions would not qualify as a conflict event if the functions are performed at non-overlapping time periods. An example is if the pre-existing function is to play a Song 1, and the candidate function to play Song 2 is either received after the performance of Song 1 or includes a time limitation that does not overlap with the performance of Song 1. For example, the candidate function may be to “play Song 2 after Song 1” or at a particular time in the future that is after Song 1 is over. In another example, if the pre-existing function is to play a playlist or an album, the function is performed for a time period that extends until the end of the playlist or album. Conflicts may occur until that playlist or album ends.

Another example is a pre-existing function to set the lights at a specific level during a first time range (e.g., 5 PM to 9 PM). If the candidate function is to set the lights at a different level during a second time range that does not overlap the first time range, there is no conflict. There would be a conflict, though, if the performance of the candidate function would potentially overlap the first time range, such as if the lights are set at 4 PM to a level that differs from the specified level to be effected at 5 PM. In this situation, the DA device 100 may determine the conflict event to occur at a particular time in the future. The DA device 100 may perform the newly-received function until the time of conflict. In this lighting example, the DA device 100 may set the lights to the level according to the candidate function at 4 PM and may maintain the lights at that level at least until the time of the conflict, 5 PM. At the time of the conflict, the function with higher priority is performed. The function with lower priority is not performed, as described herein.

In an embodiment, the DA device 100 may support functions that dictate negative performance, referred to as lockout functions. For example, the pre-existing function, provided by a first user, may be to not accept voice commands of other users for a designated period of time. The DA device 100 is then locked-out from performing voice commands received by people other than the first user during the designated lock-out period. The DA device 100 determines a conflict when a voice command is provided, by other than the first user, which instruct a function to be performed during the lock-out period. For example, if the candidate function is to play a song, such function would interfere with the performance of the lockout function, even if the song would not interfere with any previously-selected song being played.

If the one or more processors determine that there is no conflict, then flow proceeds to step 210. At step 210, the one or more processors determine whether the source of the voice command has authority to command the performance of the candidate function. Different functions may require different levels or classes of authority before the DA device 100 approves and performs the function. The categorization of functions to different levels of authority may be performed by customizing settings stored in a memory associated with the DA device 100. Example functions that may be classified as a low authority level may include playing a song, turning on lights, asking for public information (e.g., weather, news, sports, etc.), and the like. A second, intermediate authority level may be reserved for functions such as controlling appliances in a building (e.g., oven, microwave, HVAC, etc.), and asking for or updating personal information about a specific user or documents associated with the specific user. The documents associated with a specific user can include a to-do list, a shopping list, a calendar, and the like. A third, high authority level may be reserved for functions such as turning on and off a security system, requesting and/or updating passwords, making purchases via the DA device 100, and the like. There may be more or less than three authority levels in other embodiments.

The user database may indicate an authority level for each of the known users. For example, the authority levels of the users may be provided in the hierarchical table 124. The authority level may be selected by a primary user when setting up or updating settings of the DA device 100. The primary user may be a person that has credentials (e.g., password and/or status) to qualify as having the highest authority level. In a home environment, the parents, adult couple, or head of household may serve as primary users. Thus, a primary user has authority to deliver voice commands instructing performance of any of the different classes or categories of functions. Users that are designated as having a second tier of authority are authorized to voice command functions within the low and middle authority levels, but are not authorized to request functions within the high authority level. As such, a user with a second tier authority level may not be able to turn off the security system or make purchases by voice command. Users designated as having a third tier of authority may only be authorized to voice command functions within the low authority level, such as to control music, lights, ask for public information, and the like. Third tier users may not be allowed to voice command performance of functions in the middle and high authority levels. In an embodiment, a primary user can individually customize the functions permitted to be requested by each of the users. If the source of a voice command is unrecognized, the DA device 100 may by default place the unrecognized user in the lowest authority level. This verification process ensures that strangers are not able to take advantage of primary users by asking the digital assistant to turn off a security system, make purchases using stored financial information, and the like.

If the source of the voice command is verified to have sufficient authority for the function requested, then flow proceeds to step 212 and the one or more processors perform the candidate function according to the voice command. Performing the candidate function may involve the one or more processors generating a control signal that is communicated to an external device or appliance for controlling operation of the external device or appliance. As described above, suitable external devices and appliances that may be controlled by the DA device 100 can include audio speakers, lights, thermostat and/or other HVAC equipment, kitchen appliances (e.g., oven, range/stove, refrigerator, microwave, etc.), security system, lawn sprinkler, television, and the like. If the function involves a responding to a request for information, performing the function may include routing the request to an appropriate web service, receiving a response from the web service, and then generating a control signal to emit a speech message to the source of the voice command via one or more audio speakers. The speech message may be “spoken” by a robotic voice. The speech message includes a response to the request for information. In another example, if the candidate function is to update information stored in a memory, such as a list (e.g., to-do, shopping list, etc.), a note, a calendar, and the like, to set a reminder or alarm, or the like, the function may be performed by generating and storing data representative of the function. The data may be stored locally within the memory of the DA device 100 and/or remotely within a memory of a computer or server communicatively connected to the DA device 100 via a network.

On the other hand, if the source of the voice command does not have sufficient authority to command the first function, then flow proceeds to step 214 and the one or more processors do not perform the candidate function. The one or more processors 118 of the DA device 100 may deny or constructively ignore the voice command. Optionally, the one or more processors may notify the source of the voice command that the voice command is denied (e.g., that the candidate function will not be performed). The one or more processors may notify the source by generating an output notification, such as activating a red flashing light, displaying a text message on a display of the DA device 100, wirelessly communicating a message from the DA device 100 to an external device (e.g., smartphone), emitting a designated sound, and/or the like.

Returning to step 208, if the one or more processors determine the existence of a conflict between the candidate function and the pre-existing function, then flow proceeds to step 216. At step 216, the one or more processors determine whether the source of the voice command, as identified, has authority to override or supersede the pre-existing function. This determination may be based on whether the source of the voice command has priority over a user that is the source of the pre-existing function. If the identified source of the voice command has a higher ranking relative to the source of the pre-existing function, then the source of the voice command has the authority to override and supersede the pre-existing function with the candidate function. If, on the other hand, the identified source of the voice command is ranked lower than the source of the pre-existing function, then the source of the voice command does not have authority to override the pre-existing function with the candidate function.

The hierarchy of users may be a record contained in a user database stored in the memory 120 of the DA device 100 and/or within a remote computer or server. In an embodiment, the record is the hierarchical table 124 in the memory 120. The hierarchical table 124 may list plural users and respective rankings of the users relative to one another. Functions commanded or set by users of higher ranking according to the hierarchical table 124 take priority over functions commanded or set by lower-ranked users.

FIG. 3 illustrates the hierarchical table 124 according to an embodiment. The hierarchical table 124 lists information about multiple users of the DA device 100. The table 124 includes a name column 302, a title column 304, an authority rank column 306, and an authority level column 308. The name column 302 provides a unique identifier for each user. The unique identifier may be a personal name, a user name, an employee identification number, or the like. The title column 304 provides a title of each user. The title may be a job title in a business context, a family title in a home context, or the like. The authority rank column 306 provides a relative ranking of the users from highest rank to lowest rank. The table 124 in FIG. 3 includes six users ranked from #1 to #6. Mary, the mother, is ranked highest, and Ernie, the neighbor, is ranked lowest. The rankings are used to resolve conflicting voice commands.

The authority level column 308 provides a level, tier, or class of authority for each of the users, similar to a security clearance level. The authority level may be similar to the rankings in the rank column 306, except that the authority level does not rank users relative to each other. For example, multiple users may have the same authority level. The users may be assigned to different authority levels based on age, experience, aptitude, position, role, or the like. In the illustrated embodiment, the two parents, Mary and George, have the top authority level. Clarence, Violet, and Sam have a middle authority level, and Ernie has the bottom or lowest authority level. The authority levels are used by the DA device 100 to determine whether a particular user that submits a voice command has permission to request the DA device 100 perform a specific requested function. For example, users with the high authority level have permission to request the DA device 100 to perform certain functions that users with mid and bottom authority levels do not have authority to request.

The rankings may be set and altered by a primary user of the DA device 100. Primary users may, by default, be ranked higher than users having lower authority levels. In addition, unrecognized users may be allocated a lower ranking than all known users present in the hierarchical table.

In an embodiment, the ranking order of the users may be generated and/or modified based on behavioral analysis of plural voice commands received by the one or more microphones 106 of the DA device 100 over time. For example, the one or more processors may use machine learning to discern trends in the voice commands over time, and may generate and/or adjust the rankings based on the trends. The one or more processors may include a neural network that performs the machine learning. The one or more processors may analyze previous voice commands received by the DA device 100 to observe various factors. Suitable factors can include a total number (e.g., volume) of voice commands provided by each user, types of candidate functions requested in the voice commands by each user, a rate or prevalence at which the voice commands of each user are involved in conflicts with other functions, a result of the voice command conflicts in which each user is involved in, temporal characteristics of the voice commands, and the like. The temporal characteristics may represent whether the voice commands are submitted by the user consistently over time, or are bunched such that most occurred earlier in a time window than later in the window, or vice-versa.

In an example, higher numbers of diverse voice commands may weigh in favor of increasing the ranking of a user. Recognizing a voice more often could increase that user's ranking, at least slightly. Alternatively, a low number of voice commands may weigh in favor of reducing the ranking of the user due to inactivity or non-use. A large number of voice commands may not increase the ranking if the voice commands are not diverse. For example, a child repeatedly requesting his or her favorite children's song would not be sufficiently diverse to increase the ranking of that child, even if the number of voice commands is large. In another example, if the analysis indicates that a user has had relatively few voice commands involved in conflicts and/or that the user has prevailed in a relatively high percentage of the conflicts, then the ranking of the user may be increased. For example, a person in a high ranking position of the environment (e.g., a parent or boss), may not have their voice commands challenged that often, so a low percentage of voice commands that are involved in a conflict could indicate that the user has high authority, so the ranking may be increased. The same is true if the voice commands provided by the user often prevail during conflicts. Conversely, if the voice commands submitted by a first user are often superseded by a higher-ranked user, then the ranking of the first user may be reduced at least slightly. Over time, this behavioral analysis may cause two users to switch places in the ranking order.

Optionally, the hierarchical table 124 may include different user ranking orders for different categories of functions. For example, a first user may have a higher ranking than a second user with respect to controlling music, the first user may have a lower ranking than the second user with respect to controlling light settings. These category-specific rankings may be specified and customized by a primary user in the settings of the DA device 100. If the hierarchical table 124 does include category-specific rankings, then the one or more processors, in response to determining the conflict, identifies which category is associated with the candidate function of the voice command. The one or more processors then access the specific ranking order associated with that category to determine whether the source of the voice command is ranked higher than a source of the pre-existing function.

If the one or more processors determine at step 216 that the source of the voice command, as identified, has authority to override or supersede the pre-existing function, then flow proceeds to step 210. Once it is determined that the source also has the authority to command the performance of the first function, then the one or more processors perform the first function at step 212. In an embodiment, the one or more processors may perform the first function by initially stopping the performance of the pre-existing function and then subsequently starting performance of the candidate function. In this order, there is no overlap between the two conflicting functions.

Optionally, the controller 102 of the DA device 100 may generate a control signal to notify the source of the pre-existing function that the pre-existing function has been superseded by a user of higher rank. For example, the control signal may be wirelessly communicated to a personal computing device (e.g., smartphone) of the person that commanded the pre-existing function. The computing device that receives the control signal may provide a text-message on a display to inform the person the reason that the performance of the pre-existing function has been prematurely ended.

On the other hand, if the one or more processors determine at step 216 that the source of the voice command does not have authority to override the pre-existing function, then flow proceeds to step 214, and the one or more processors do not perform the candidate function. Optionally, the controller 102 may generate a control signal to notify the source of the voice command that the voice command is denied. The notification may indicate that the reason why the voice command is denied is due to being outranked by another user that requested a conflicting function. Optionally, the notification may provide an estimated time at which there would be no conflict and the candidate function would be permitted. For example, if the pre-existing function is to play a music album, then the controller 102 may provide an estimated time at which the album is over. The notification may include an offer to perform the candidate function (of the denied voice command) at the estimated time at which the album is over. The user may respond to the offer via a voice command. If the user responds in the affirmative, the controller 102 schedules the performance of the candidate function for a time that is after the album ends.

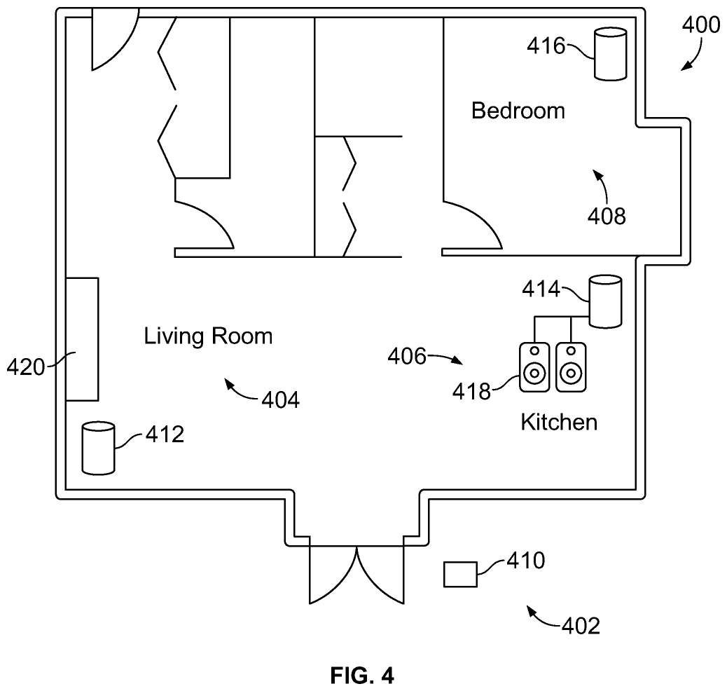

FIG. 4 illustrates a top plan view of an environment in which embodiments herein may be implemented. The environment 400 may represent a house, apartment/condo, office, school, or other building. In the example of FIG. 4, the environment 400 represents a home, such as a house, apartment, condo, townhouse, or the like. The home includes an outdoor area 402, a living room area 404, a kitchen area 406, and a bedroom area 408. Several electronic devices 410, 412, 414, 416 are distributed throughout the environment 400. As one example, all of the electronic devices 410, 412, 414, 416 may offer DA functionality, such that all of the electronic devices represent DA devices. Alternatively, one or more of the electronic devices 410, 412, 414, 416 may not offer DA device functionality. The electronic devices 410, 412, 414, 416 may be connected to one another via a network to represent a smart-enabled device ecosystem.

With reference to the example of FIG. 4, a first person within the kitchen area 406 may direct a verbal voice command to the local electronic device 414. The voice command may be, “Play blues music inside the entire home”. The DA application of the electronic device 414 may interpret the requested candidate function as to play blues genre music through the speakers of each of the connected electronic devices 412, 414, and 416 within the home. The one or more processors may perform the conflict resolution algorithm 122, as explained herein, to determine if the candidate function would create any conflicts with pre-existing functions.

For example, if a second person within the bedroom area 408 is listening to a podcast via the electronic device 416 at the time that the first person lodges the voice command to the electronic device 414, the playing of the podcast represents a pre-existing function. The one or more processors of the electronic device 414 determine that playing blues music via the electronic device 416 in the bedroom would conflict with the podcast. The one or more processors then determine which person has priority over the other person. If the first person in the kitchen is a user having greater authority than the second person in the bedroom, the electronic device 414 controls the electronic device 416 in the bedroom to play blues music according to the voice command, overriding the podcast. Conversely, the blues music does not supersede the podcast if the one or more processors determine that the second person in the bedroom has a greater ranking than the first person in the kitchen.

In an embodiment, the DA devices disclosed herein may resolve multi-part conflicts by treating each conflict individually. In the example described above, a third person may be watching television 420 in the living room area 404 and a fourth person may be listening to music outside through the exterior electronic device 410. Upon receiving the voice command from the first person in the kitchen area 406 to play blues music throughout the home, the DA application 125 of the electronic device 414 in the kitchen may analyze whether performance of such a function would conflict with pre-existing functions of any of the other electronic devices 410, 412, 416. The electronic device 414 may determine that there is no conflict with the exterior electronic device 410 that plays a different type of music outside because of the walls and space separating the two devices 410 and 414. For example, the person outside would not hear the blues music being played inside, and the person listening to blues in the kitchen would not hear the music outside. As described above, the electronic device 414 may determine that there is a conflict with the electronic device 416 in the bedroom playing a podcast. Furthermore, the DA application 125 may also determine that there is a conflict with the electronic device 412 in the living room which may be performing a function associated with the third user watching television 420.

The one or more processors of the electronic device 414 may perform a separate and discrete conflict resolution analyses for each of the two detected conflicts. In one example scenario, the first person in the kitchen may rank higher than the third person in the living room and lower than the second person in the bedroom. As a result, the blues music would be played on the speakers 418 in the kitchen and the electronic device 412 in the living room. Because the third person in the living room is outranked by the voice command of the first person, the electronic device 412 may mute, pause, and/or turn off the television 420 while the blues music is played by the speakers 418 and the electronic device 412 in the living room. The electronic device 416 in the bedroom may continue to play the podcast because the second person in the bedroom outranks the first person in the kitchen. The electronic device 410 outside continues to the play the music selected by the fourth person outside because there is no conflict detected with the blues music being played inside.

In an example, the second person in the bedroom may subsequently verbalize a voice command to the electronic device 416 to stop the blues music that is being played in the kitchen and living room. This new command to stop the performance of the blues music creates a conflict with the pre-existing function of playing blues music. Because the second person is ranked higher than the first person in the kitchen according to the user hierarchy, the electronic devices according to the conflict resolution algorithm respond by granting the second person's request to cease playing the blues music. If the first person in the kitchen then attempts to start the blues music again, the electronic device 414 would deny the request because the latest voice command conflicts the instruction provided by the higher-ranking second person in the bedroom. Although the example described above involves listening to audio, the electronic devices of the home may perform the conflict resolution algorithm to resolve conflicts based on a variety of different functions. Suitable functions can include control of light settings, thermostat settings, security system settings, appliance operations, and the like. Furthermore, the conflict resolution algorithm may be applied outside of the home, such as in workplace/business environments, schools, retail establishments, and the like.

The DA device and method described herein provides various algorithms for ranking users and using the user rankings to resolve conflicting voice commands. A technical effect is that the functions performed by the DA device may experience fewer interruptions resulting in more efficient, convenient, and entertaining operation of the DA device.

### Closing Statements

As will be appreciated by one skilled in the art, various aspects may be embodied as a system, method or computer (device) program product. Accordingly, aspects may take the form of an entirely hardware embodiment or an embodiment including hardware and software that may all generally be referred to herein as a “circuit,” “module” or “system.” Furthermore, aspects may take the form of a computer (device) program product embodied in one or more computer (device) readable storage medium(s) having computer (device) readable program code embodied thereon.

Any combination of one or more non-signal computer (device) readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection. For example, a server having a first processor, a network interface, and a storage device for storing code may store the program code for carrying out the operations and provide this code through its network interface via a network to a second device having a second processor for execution of the code on the second device.

Aspects are described herein with reference to the Figures, which illustrate example methods, devices and program products according to various example embodiments. These program instructions may be provided to a processor of a general purpose computer, special purpose computer, or other programmable data processing device or information handling device to produce a machine, such that the instructions, which execute via a processor of the device implement the functions/acts specified.

The program instructions may also be stored in a device readable medium that can direct a device to function in a particular manner, such that the instructions stored in the device readable medium produce an article of manufacture including instructions which implement the function/act specified. The program instructions may also be loaded onto a device to cause a series of operational steps to be performed on the device to produce a device implemented process such that the instructions which execute on the device provide processes for implementing the functions/acts specified.

The units/modules/applications herein may include any processor-based or microprocessor-based system including systems using microcontrollers, reduced instruction set computers (RISC), application specific integrated circuits (ASICs), field-programmable gate arrays (FPGAs), logic circuits, and any other circuit or processor capable of executing the functions described herein. Additionally, or alternatively, the units/modules/controllers herein may represent circuit modules that may be implemented as hardware with associated instructions (for example, software stored on a tangible and non-transitory computer readable storage medium, such as a computer hard drive, ROM, RAM, or the like) that perform the operations described herein. The above examples are exemplary only, and are thus not intended to limit in any way the definition and/or meaning of the term “controller.” The units/modules/applications herein may execute a set of instructions that are stored in one or more storage elements, in order to process data. The storage elements may also store data or other information as desired or needed. The storage element may be in the form of an information source or a physical memory element within the modules/controllers herein. The set of instructions may include various commands that instruct the modules/applications herein to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. Further, in the following claims, the phrases “at least A or B”, “A and/or B”, and “one or more of A and B” (where “A” and “B” represent claim elements), are used to encompass i) A, ii) B or iii) both A and B.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

What is claimed is:

1. A digital assistant (DA) device, comprising:
a housing;
one or more microphones held by the housing and configured to receive a voice command;
a memory configured to store program instructions; and
one or more processors operably connected to the memory, wherein the program instructions are executable by the one or more processors to:
interpret the voice command received by the one or more microphones as instructing performance of a first function;
identify a source of the voice command;
determine whether the performance of the first function would conflict with performance of a second function;
in response to determining that the performance of the first function would conflict with the performance of the second function, determine whether the source of the voice command has authority to override the second function; and
perform the first function according to the voice command in response to determining that the source of the voice command has the authority to override the second function.

2. The DA device of claim 1, wherein the one or more processors are configured to identify the source of the voice command by performing voice recognition analysis of the voice command to associate the voice command with a voice of a particular person.

3. The DA device of claim 1, wherein the one or more processors are configured to determine whether the performance of the first function would conflict with the performance of the second function by determining whether the performance of the first function would interfere with at least one of an ability of the DA device to perform the section function or a reception of the second function by an observer.

4. The DA device of claim 1, wherein the one or more processors are configured to determine whether the source of the voice command has authority to override the second function by consulting a database that includes user rankings, wherein the one or more processors determine that the source of the voice command has the authority to override the second function in response to the source of the voice command having a greater ranking in the database than a user that commanded the second function.

5. The DA device of claim 4, wherein the one or more processors are configured to modify the user rankings in the database based on a behavioral analysis of plural voice commands received by the one or more microphones over time.

6. The DA device of claim 1, wherein, responsive to determining that the source of the voice command does not have the authority to override the second function, the one or more processors are configured to deny the voice command such that the first function is not performed according to the voice command.

7. The DA device of claim 1, wherein the one or more processors are configured to perform the first function according to the voice command by one or more of responding to a request for information, generating a control signal to modify operation of an external device or appliance, or modifying an organizational tool.

8. The DA device of claim 1, wherein, after determining that the source of the voice command has the authority to override the second function, the one or more processors are configured to confirm that the source of the voice command has authority to command the performance of the first function prior to performing the first function.

9. The DA device of claim 8, wherein the one or more processors are configured to confirm that the source of the voice command has the authority to command the performance of the first function by consulting a user database that lists an authority level for the user, and comparing the authority level of the user to an authority level in which the first function is categorized.

10. A method comprising:
receiving a voice command via one or more microphones of a digital assistant (DA) device, the voice command instructing performance of a first function;
identifying a source of the voice command;
determining whether the performance of the first function would conflict with performance of a second function;
in response to determining that the performance of the first function would conflict with the performance of the second function, determining whether the source of the voice command has authority to override the second function; and
in response to determining that the source of the voice command has the authority to override the second function, performing, by the DA device, the first function according to the voice command.

11. The method of claim 10, wherein identifying the source of the voice command comprises performing voice recognition analysis of the voice command to associate the voice command with a voice of a particular person.

12. The method of claim 10, wherein determining whether the performance of the first function would conflict with the performance of the second function comprises determining whether the performance of the first function would interfere with an ability of the DA device to perform the section function or a reception of the second function by an observer.

13. The method of claim 10, wherein determining whether the source of the voice command has authority to override the second function comprises consulting a database that includes user rankings, and the source of the voice command is determined to have the authority to override the second function in response to the source of the voice command having a greater ranking in the database than a user that commanded the second function.

14. The method of claim 13, further comprising modifying the user rankings in the database based on a behavioral analysis of plural voice commands received by the one or more microphones of the DA device over time.

15. The method of claim 10, wherein, responsive to determining that the source of the voice command does not have the authority to override the second function, the method comprises denying the voice command such that the first function is not performed.

16. The method of claim 10, wherein performing the first function according to the voice command comprises one or more of responding to a request for information, generating a control signal to modify operation of an external device or appliance, or modifying an organizational tool.

17. The method of claim 10, wherein, after determining that the source of the voice command has the authority to override the second function, confirming that the source of the voice command has authority to command the performance of the first function prior to performing the first function.

18. The method of claim 17, wherein the source of the voice command is confirmed as having the authority to command the performance of the first function by consulting a user database that lists an authority level for the user and comparing the authority level of the user to an authority level in which the first function is categorized.

19. A computer program product comprising a non-transitory computer readable storage medium, the non-transitory computer readable storage medium comprising computer executable code to:
receive a voice command via one or more microphones of a digital assistant (DA) device, the voice command instructing performance of a first function;
identify a source of the voice command;
determine whether the performance of the first function would conflict with performance of a second function;
in response to determining that the performance of the first function would conflict with the performance of the second function, determine whether the source of the voice command has authority to override the second function; and
in response to determining that the source of the voice command has the authority to override the second function, perform the first function according to the voice command.

20. The program product of claim 19, wherein the non-transitory computer readable storage medium further comprises executable code to identify the source of the voice command by performing voice recognition analysis of the voice command to associate the voice command with a voice of a particular person.
